(19) United States
(12) Patent Application Publication
(10) Pub. No.: US 2003/0220871 A1
(43) Pub. Date: Nov. 27, 2003

(54) Customizable electronic bill presentment and payment system and method

(76) Inventors: William D. Clarke, Florence, MA (US); Robert A. Laprade, Hadley, MA (US); Daniel M. Palma, Wilbraham, MA (US)

Correspondence Address: PITNEY BOWES INC., 35 WATERVIEW DRIVE, P.O. BOX 3000, MSC 26-22, SHELTON, CT, 06484-8000, US

(21) Appl. No.: 10/153,105

(22) Filed: May 22, 2002

(51) Int. Cl. G06F 17/60

(52) U.S. Cl. 705/40

(57) ABSTRACT

An customizable electronic bill presentment computer system for providing bill information from a biller to a remote customer over a network. The system processes a requested transaction from a customer through an interaction controller that utilizes stored scripts of instructions in an action descriptor repository. The action descriptor repository includes customized instructions for controlling business objects and presentation objects. The action descriptor repository and a presentation descriptor repository are maintained discrete from the business logic, presentation logic, and interaction controller, thereby providing that the repositories are the only part of the system directly reflecting the biller's particular electronic billing needs, the information in the repositories being customizable for the biller.

### TECHNICAL FIELD

The present invention relates to a customizable electronic bill presentment and payment (EBPP) system using a dynamic model/view/controller architecture.

### BACKGROUND

Many organizations are becoming more involved in conducting business electronically (so called e-business), over the Internet, or on other computer networks. E-business calls for specialized applications software such as Electronic Bill Presentment and Payment (EBPP) and Electronic Statement Presentment applications. To implement such applications, traditional paper documents have to be converted to electronic form to be processed electronically and exchanged over the Internet, or otherwise, with customers, suppliers, or others. The paper documents will typically be re-formatted to be presented electronically using Hypertext Markup Language (HTML) Web pages, e-mail messages, Extensible Markup Language (XML) messages, or other electronic formats suitable for electronic exchange, processing, display and/or printing.

Billers who provide their customers with the option of viewing and paying their bills over the Internet have varying requirements for the business content to be provided. In addition to varying content, different billers will want the customer interface and presentation of the billing information to have a particular “look-and-feel.”

Instead of programming their own EBPP system from scratch, billers have the option of purchasing or outsourcing a pre-made EBPP system from a vendor. The biller may also hire a third party electronic billing service to provide the desired EBPP services to the biller's customers. In any of these situations, a pre-made EBPP system must be customized to meet the particular business and presentation requirements of the biller. Accordingly, a vendor who provides an EBPP solution to multiple billers needs to consider the extent to which its system can be customized, and the ease with which customization can be achieved.

FIG. 1 depicts a prior art EBPP system. In the prior art system, for one or more billers, EBPP computer system 10 controls the presentment of billing service web pages 40 over the Internet 2 to customer 1. Billing information is gathered by EBPP computer system 10 from the biller's legacy computer systems 20. Typically, billing data will be parsed by EBPP system 10 from a print stream generated by the legacy system 20, the legacy print stream being originally intended for printing conventional hard-copy bills. A preferred method for parsing billing data from the legacy print stream is described in co-pending U.S. patent application Ser. No. 09/502,314, titled Data Parsing System for Use in Electronic Commerce, filed Feb. 11, 2000, which is hereby incorporated by reference into this application.

In addition to communication via web pages 40 generated during a session, EBPP computer system 10 includes the capability of sending and receiving e-mail messages 50 to and from the user 1. Typically, system 10 will generate a message to user 1 upon the occurrence of a predetermined event. An example of such an event is a new billing statement becoming available, or the approach of a due date for an unpaid bill. EBPP system 10 is also capable of communicating with a bank or ACH network 30 to process bill payment activities.

System 10 includes a data repository 11 in which billing data for use with system 10 may be stored in a variety of formats. Data in the repository can be organized in a database, such as the kind available from Oracle or DB2. Statement data archives may also be stored in a compressed XML format. XML is a format that allows users to define data tags for the information being stored.

The EBPP computer system 10 itself is typically comprised of standard computer hardware capable of processing and storing high volumes of data, preferably utilizing a J2EE platform. EBPP system 10 is also capable Internet and network communications. Of interest with respect to the present patent application, the prior art EBPP computer system 10 includes a software architecture within an application server 12 for generating and handling electronic billing functions. At a fundamental level, the software architecture of the prior art system 10 is split into two conceptual components, the front-end presentation logic 13 and the back end servicing logic 14. The split between front-end and back-end logic 13 and 14 serves to reduce the amount of recoding necessary for the system to be customized for different billers.

The front-end presentation logic 13 is the portion of the software that is the primary Internet interface for generating web page presentations. As such, the front end presentation logic 13 includes code that is custom written to meet the specific business and presentation needs of the biller. Functionality that might be included in front-end logic 13 is enrollment, presentation, payment instructions, and reporting.

Typically, front-end logic 13 is comprised of Java Server Pages (JSP's) that control the presentation of billing information in the form of web pages. The front-end logic JSP's also receive and respond to inputs as the customer makes requests for various services to be provided. The JSP's can be recoded to accommodate different look-and-feel and business requirements of different billers. Within the JSP's, front-end logic 13 can also utilize Enterprise Java Beans (EJB's) that comprise objects for performing specific tasks.

The back-end services logic 14 comprises the software for functions that typically do not need to be customized for particular billers. Preferably, very little of the back-end services must be customized for a particular biller's needs. For example, back-end logic may include the software for extracting the billing data from the biller legacy billing computers 20. Similarly, logic for handling of payments with the bank or ACH network 30 and systems for generating and receiving e-mail messages will be handled in the back-end services logic 14.

As a result of the distinction between the front-end and back-end logic 13 and 14, re-coding of software to provide customization for different billers is somewhat reduced. However, a significant amount of presentation logic and some business logic must always re-written to meet a particular biller's needs. The re-coding required for customization can require a high degree of programming skill and can add expense to implementation of a biller's on-line presence. The requirement for re-writing code introduces a risk that changes to the way that a web page looks may in fact introduce a problem that could cause the content of the information being displayed to be incorrect. Another problem with this prior art system is that after a system is customized it may be difficult to provide upgrades and future releases of the software. In order to be sure that new releases work properly substantial efforts would be necessary to retrofit the new release with the code changes that were made for the particular biller.

As will be described in more detail below, a preferred embodiment of the present invention is an expansion on a Model-View-Controller (MVC) software design architecture. An example of a system using the MVC concept is Apache Jakarta Struts Project (Struts) (see http:jakarta.apache.org/struts). Known MVC architectures such as Struts, however, fail to address the problems caused by the need for customization described above. If one were to attempt customization electronic billing presentations using a known Struts architecture, changes to code, recompiling, and debugging would still be required, because business and presentation variations must still be re-coded and recompiled in the controller, the model, and/or the view components.

In the prior art, certain Internet services such as “Yahoo!” and “Excite” have allowed registered users to create personalized web pages. Such personalized web pages allow the user to select certain information and presentations of the information available from the service. When the registered user visits the web site and is recognized, the user's selected information and arrangement is displayed. For example, the user may choose to see an arrangement including a weather report for his region, sports scores for his favorite teams, and stock quotes for his investment portfolio. These personalization features, however, do not provide a way for a biller to offer EBPP services customized to its particular business and presentation needs.

Accordingly, the prior art leaves disadvantages and needs to be addressed by the present invention, as discussed below.

### SUMMARY OF THE INVENTION

The present invention provides a customizable EBPP system whereby the business logic and presentation logic need not be changed to provide customization to different billers. Rather, customization features are stored in data repositories, preferably in XML format, whereby a controller activates appropriate objects and routines within the business and presentation logic based on the stored customization features. Accordingly, customization for a particular biller is achieved by changing data stored in a repository, rather than reprogramming core logic.

The electronic bill presentment computer system of the present invention provides bill information from a biller to a remote customer over a network. At the beginning of a transaction session, the customer submits a requested transaction to the electronic bill presentment computer system. The electronic bill presentment computer system comprises standard computer hardware configured and programmed to include the necessary software components and storage facilities.

A first storage facility, called a presentation descriptor repository, stores data pertaining to the biller's particular look-and-feel for presentation of electronic billing results to the customer. The software for the system includes a presentation logic module that prepares a visual presentation of results of the requested transaction from the system to the customer. The presentation logic module retrieves look-and-feel data from the presentation descriptor repository to generate the presentation.

The preferred embodiment of the present invention also includes an action descriptor repository. The action descriptor repository comprises stored scripts of processing instructions corresponding to a wide variety of potential transactions allowed by a particular biller. The scripts are customized to particular electronic bill requirements of the biller and can include identifications of business objects to instantiate, methods to invoke the business objects, and presentation instructions. The preferred embodiment further includes a non-customized business logic module including a plurality of business objects for determining electronic billing results based on the customer's request. A variety of business objects are supplied with the basic system to offer a wide range of functionality that can be customized.

An interaction controller serves as the central means for directing the operation of the various components of the system. The controller receives the requested transaction from the customer and retrieves the corresponding script of processing instructions from the action descriptor repository. Then the controller invokes the appropriate business objects in the business logic module in accordance with the action descriptor scripts from the action descriptor repository. The controller also provides basic presentation instructions to the presentation logic module in accordance with the customized script instructions.

An important feature of the invention is that the action descriptor repository and the presentation descriptor repository be discrete from the business logic module, the presentation logic module, and the interaction controller. In a further preferred embodiment, the repositories store the respective instructions relating the particular billers' requirements in XML format. This format provides flexibility by allowing user designated tags, and ease of use with different types of software applications. This arrangement of the repositories and logic modules provides that the repositories are the part of the system directly reflecting the biller's particular electronic billing needs. The information in the repositories can then be customized without requiring recoding of the base code for the system. Also, this arrangement allows that the base code can be upgraded relatively easily for a variety of billers who have adopted the present invention to fulfill their EBPP needs.

Other variations on the basic invention will be described in the detailed description and the enumerated claims below.

### BRIEF DESCRIPTION OF DRAWINGS

The present invention is illustrated by way of example, in the figures of the accompanying drawings, wherein elements having the same reference numeral designations represent like elements throughout and wherein:

FIG. 1 is a prior art EBPP system;

FIG. 2 is a customizable EBPP system according to the present invention;

FIG. 3 is a sample HTTP request and corresponding XML action descriptor for use with the present invention;

FIG. 4 is a sample look-and-feel template stored in XML format for use with the present invention; and

FIG. 5 represents a typical web page layout that could be generated using the presentation features of the present invention.

### DETAILED DESCRIPTION OF THE INVENTION

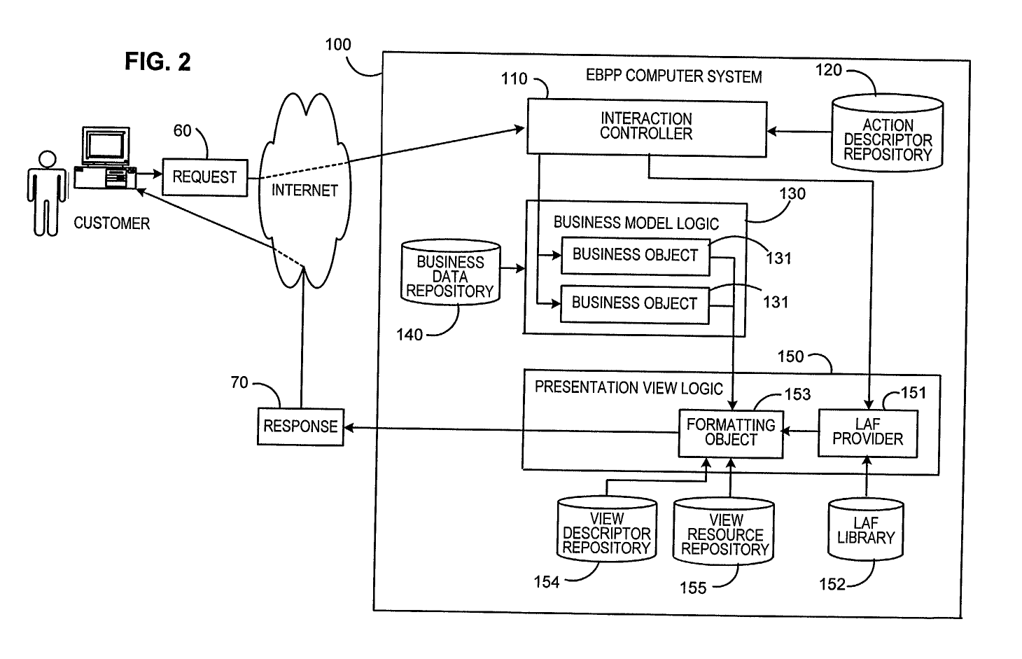

A customizable EBPP system in accordance with the present invention is depicted in FIG. 2. EBPP computer system 100 includes an EBPP software product in accordance with the present invention that can be extended and customized without inhibiting subsequent upgrades and without modifying the base code set for the product. In part, this is accomplished by incorporating what will be referred to as a dynamic model-view-controller methodology.

To a customer 3, interacting with the EBPP system 100 of the present invention through the Internet 2, the functionality and presentation of information on a EBPP web page will not necessarily be distinguishable from a prior art EBPP system 10. However, the manner in which EBPP computer system 100 processes interactions with customer 3 will be significantly different.

At the beginning of a session, a customer 3 uses an Internet browser (Netscape, Internet Explorer, etc.) to visit the biller's EBPP website. To initiate an EBPP transaction the customer 3 will click on a button or a link on a web page that will cause a transaction request 60 to be sent to the web server housing the EBPP system 100. The request 60 is typically in HTTP format, and includes a URL parameter for the customer 3. Request 60 is processed by EBPP system 100 and an appropriate response 70 is presented, typically in the form of a web page. This interaction continues as long as the customer 3 is accessing the web site.

In the preferred embodiment of the invention, the processes for generating the response 70 based on the request 60 can be described as using a novel “dynamic MVC” architecture or methodology. The system is “dynamic” in the sense that the same model, view, and control related components can be used to provide customized EBPP service using a common set of base code. The dynamic aspect of the invention relies on customized data stored independently of the core logic. The customized data can be interpreted as instructions that activate the specially designed logic modules in a manner that they can provide a very wide range of customized functionality.

The business model logic module 130 represents the business logic needed to fulfill the request 60. In the preferred embodiment the business logic module 130 is comprised of business objects 131 that interact with the business data repository 140, perform calculations, and provide coordination between related objects.

Presentation logic 150 is responsible for constructing the response, which in most cases will be an HTML web page, showing the results of requests and links or buttons to allow for additional requests. The content and format of a presentation is based on content descriptors pertinent to the particular information to be presented and a look-and-feel (LAF) framework active for the current session. LAF data is stored in a repository called the LAF repository 152 and descriptor data for how to present particular results is stored in a view descriptor repository 154. Also, further data for cosmetic features such as graphics or fonts is available for use and stored in a view resource repository 155.

Interaction controller 110 processes the HTTP request and data sent from the customer and instructs the business model logic module 130 to activate the appropriate business objects 131. The interaction controller 110 also selects a presentation look-and-feel to initiate from the LAF provider 151 to prepare an appropriate presentation to send back to the customer 3 upon completion of the response to the request 60.

The controller 110 controls the processes of the business logic module 130 and the presentation view logic 150 based on sets of instructions called action descriptors that are stored in the action descriptor repository 120. For a request from a particular customer 3, the controller 110 will retrieve a corresponding action descriptor. The action descriptor is interpreted by the controller 110 for subsequently controlling logic modules 130 and 150. In the preferred embodiment of the invention, the actions descriptors are stored in XML format in the action descriptor repository 120. The XML action descriptors may then be modified relatively easily to provide customized responses for different billers, without the necessity of rewriting base code for the interaction controller 110, the business model logic module 130 or the presentation view logic module 150. XML is a preferred format because it is a universally usable language for data on the Web. Further, XML allows the creation of unique data formats to allow greater flexibility to for the purposes of allowing customization. In particular, the ability to create an unlimited number of tags in XML allows this flexibility. XML is also a good way to store information because it can be easily read and understood by humans and machines. XML has the advantage that it describes the content of the data, rather than how it should look.

In operation, the interaction controller 110 accepts an HTTP request received from the customer 3. In the preferred embodiment the controller determines actions to be invoked based on the URL parameter passed with each request. The URL parameter will indicate both the name of the dialog and the path that categorizes the dialog. For example, a request with “url=/company_profile/accounts/CompanyAccount” will invoke the dialog named “Company Account.” This dialog is associated with the path “company_profile/accounts” that basically mirrors the menu option at the web page, at customer's computer, that is used to invoke the dialog.

Once the controller 110 determines the dialog to invoke from the URL parameter, it will retrieve a corresponding action descriptor XML for that dialog from the action descriptor repository 120. The action descriptor XML will contain the instructions describing what must occur for the interaction corresponding to the request to be completed. The action descriptor preferably describes which business objects 131 to instantiate, what methods to invoke on each off the business objects 131, and based on the results of those methods, which presentation to send back to the user 3.

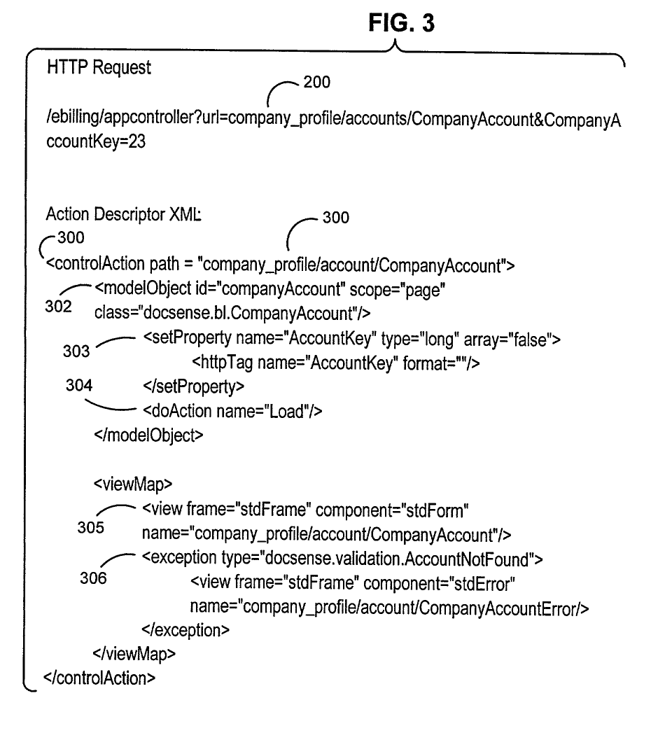

An exemplary HTTP request 200 from user 3 is depicted in FIG. 3 with a corresponding “Company Account” XML action descriptor 300. In response to the HTTP request 200, interaction controller 110 retrieves and interprets action descriptor 300. At step 301 of the script, controller 110 interprets an XML tag called “controlAction” defining responses to requests that have a particular URL parameter where “path=company_profile/account/CompanyAccount.” At step 302 of the script, instructions to controller 110 for instantiating the “CompanyAccount” class are provided for the modelObject tag. Interpreting step 303, the controller 110 will invoke a “setAccountKey” method of the CompanyAccount class, passing in a type “long” argument. The value of the type long argument will be retrieved from the HTTP request 200 parameter named “AccountKey” taken from the URL request. In the HTTP request 200 example of FIG. 3, this value is “23.” At step 304, the controller 110 initializes the business object via the doAction name=“load” call.

The XML action descriptor 300 further includes instructions for presentation of results generated by the business object 131. If the business objects return a successful completion, then at step 305 the controller 110 instructs that a responsive presentation will use the view “stdForm” that will use the form descriptor named “CompanyAccount.” If the business object fails, however, the controller will invoke an exception presentation using instead the view “stdError” and form descriptor named “CompanyAccountError,” in accordance with script step 306.

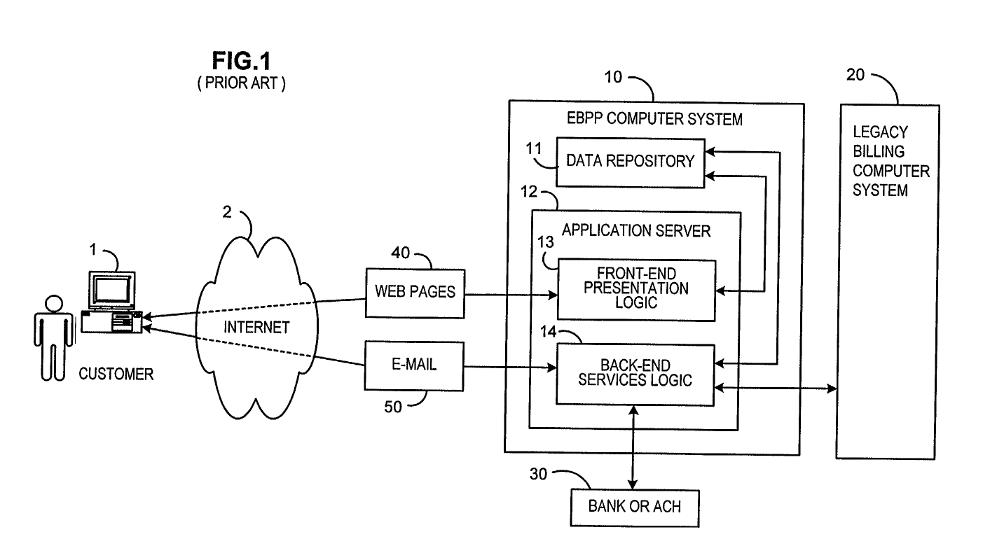

The business objects 131 within the business model logic module 130 preferably represent Java classes that will enforce certain basic business rules that are required by the system. These rules ensure the integrity of the information being manipulated in response to a request from a customer. For example, a business object “CompanyAccount,” as described above, can include provisions to ensure that the values of other fields such as a company profile identification, or a user identification are set correctly for each CompanyAccount item, without the need to explicitly set them via an instruction in the action descriptor 300. In prior art systems, much of the business rule logic was incorporated in JavaServer Pages in the front end presentation logic 13 (see FIG. 1). The prior art presentation logic 13 required re-coding to allow customization for different billers. In contrast, the present invention allows that business object 131 be constant for all billers, with the activation of those objects being customized through adjustments to the XML in the action descriptor repository 120.

Business objects 131 provide more intuitive and higher level Application-Program Interface (API) that is used by the interaction controller 110 and objects in the presentation view logic module 150. This provides the controller 110 and presentation logic 150 with more efficient means to interact with lower level items via the business objects 131. The business objects 131 effectively shield the controller 110 and presentation logic 150 from the granularity of the interaction with the basic data objects.

The business objects 131 also provide helper methods that are utilized by the presentation view logic module 150. In the case of the exemplary CompanyAccount dialog, in order for a new “UserAccount” field to be defined, it may be that values for “Publisher” and “PaymentProfile” fields must be chosen. To help the presentation logic, the CompanyAccount business object provides an API that will retrieve a list of valid Publishers (CompanyAccount.PublisherList) as well as a method to retrieve the possible payment profiles that could be used for this account (CompanyAccount.PaymentMethodList). These lists may be stored in the business data repository 140 in any desired format such as an Oracle database or XML.

The CompanyAccount business object discussed herein could also provide access to other data objects that are associated with the account that is currently loaded. For example, an “AutoPayment” object that is connected to this particular account is easily accessed via an API call to “get AutoPay.” This method call doesn't require the action descriptor to provide information about the Autopayment record. Once the appropriate script has been activated by controller 110, the business object 131 determine itself which “AutoPayment” record to use. Relevant automatic payment data would be stored in the business data repository 140.

Using this preferred embodiment of the present invention, the business objects 131 provide the API set for the general business function, not just the current interactions. Further, multiple interactions can use the same business object 131. Using the present invention, the business objects 131 can act in accordance with any number of “doAction” calls, as identified in the XML of the action descriptor repository 120, or elsewhere.

In operation, the presentation view logic module 150 provides the facilities to return a visual presentation to a user in response to an interaction request. As discussed above with respect to FIG. 3, the presentation can be determined based on the success or failure of the interaction controller 110 to execute the action descriptor.

In the preferred embodiment of the invention, a response 70 generated by the presentation view logic module 150 is an HTML web page presentation. Two factors that preferably determine the presentation of the HTML web page are the look-and-feel (LAF) active for the current request and an XML view descriptor indicated in the action descriptor.

The LAF template is derived by the LAF provider object 151 as selected from the LAF library 152. View descriptors are stored in the view descriptor repository 154. As with respect to the action descriptors, the view descriptors are preferably stored in XML format. The presentation view logic module 150 further includes a view resource repository 155 comprising data pertaining to cosmetic features such as graphics or special fonts.

The LAF template is the framework structure of the HTML presentation. The LAF template determines where the main menu will appear, where the list or form presentation will appear on the page, and the way that each of these items will appear via a reference to the appropriate style sheet definitions. The LAF provider object 151 is responsible for architecting the overall shape and positioning of content in a web page. LAF object 151 is invoked by the interaction controller 110 after the action descriptor methods for a specific request have been completed by the business model logic module 130. The LAF object 151 and the template stored in the LAF library 152 are referenced in the action descriptor in the action descriptor repository 120. The LAF object 151 has initialization parameters that reference appropriate XML in the LAF library 152 to use as a template to structure the web page.

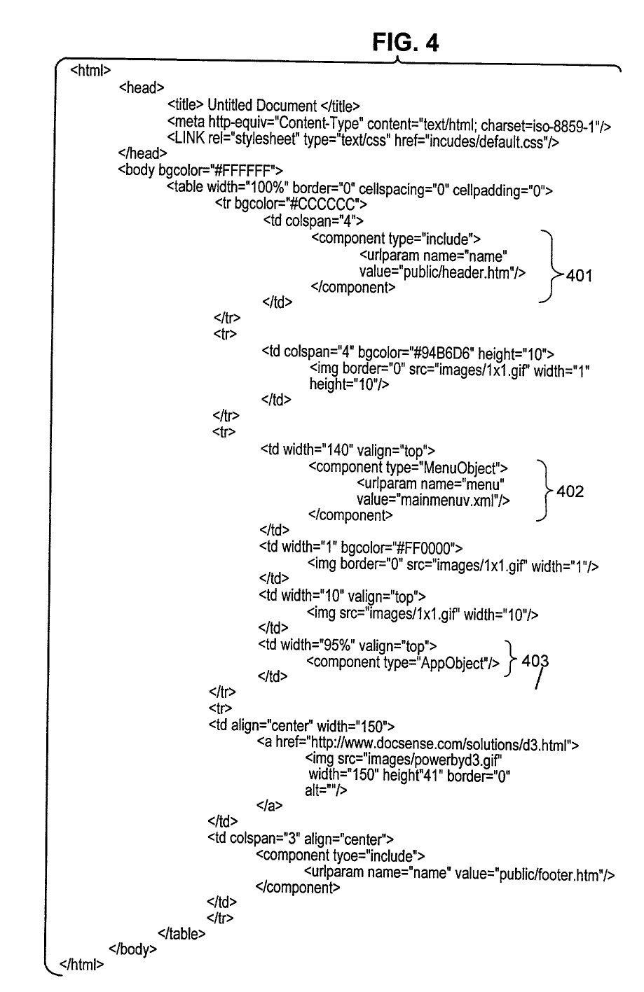

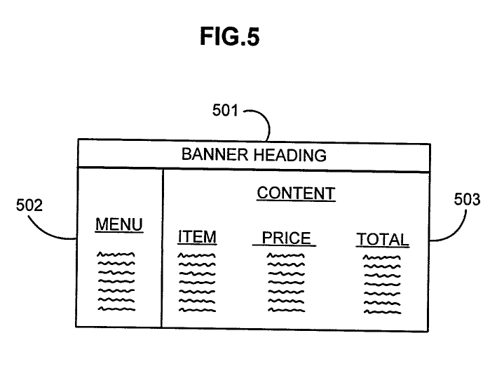

The LAF library 152 can include specific tags that identify HTML presentation parameters and presentation objects to be invoked by the LAF object 151. In the example shown in FIGS. 4 and 5, the HTML stored in the XML at step 401 may describe a page having a banner 501 across the top of the page and another step 402 may describe a menu area 502 along the left side of a certain width. The HTML for step 402 also includes HTML indicating that a presentation object called “MenuObject” should be invoked at that point to create the appropriate HTML to render a menu. Later in the XML, at step 403, a tag indicates that an object called “AppObject” should be invoked to create content to fill the defined area 503 on the right side of the page. The call for the “AppObject” of “application object” is a call to utilize the business logic results provided from a business 131 that provides a substantive result. In turn, the formatting object 153 provides the specific logic for turning the results into a format that can be inserted into the defined area 503.

An example of view descriptors in repository 154 may be scripts of instructions for presenting a “LIST” of items, or they may describe elements of an HTML FORM to be presented at the user's browser, or there may be a pointer to a simple JavaServer Page (JSP). These view descriptors are retrieved by formatting object 153 for a particular type of business result that is obtained from the business logic module 130.

The formatting object 153 (or any of the objects discussed in this application) may actually be a group of one or more objects for operating on particular business results from the business logic module 130, for presentation within the LAF template identified by the LAF provider 151. For example, if a “LIST” presentation is required by the view descriptor XML for the business results, a standard hosting object (part of formatting object 153) that uses a “listObject” class will be invoked with an argument that points “listObject” to the appropriate list descriptor in repository 154 that describes the elements and format of the list items to be presented. The list descriptor will describe each element that is to be displayed in the list and may associate that element with an API call to a business object that was invoked pursuant to an action descriptor from repository 120. Headings for list elements may be static text or references to a resource item from the view resource repository 155.

If a “FORM” type presentation is required by the view descriptor XML, a standard hosting object (again part of formatting object 153) that uses the “formObject” class will be invoked with an argument that points the “formObject” to the appropriate form descriptor. This form descriptor will describe the form elements that are to appear on the presentation. Each element will be associated with an API call to a business object 131 that was invoked by controller 110 pursuant to a stored XML action descriptor from repository 120. Any text that appears on the form such as a label for a field can be static text or may be a reference to a resource item from the view resource repository 155.

The combination of the presentation descriptors from repository 154 and the formatting objects 153 remove the responsibility of the presentation from the coding of a JSP page that was used in the prior art system in FIG. 1. Instead, the appearance of the web page as well as the content of that page is controlled via configuration information stored in the respective repositories 120, 140, 154, and 152. These respective repositories are independent of the core software code that can be provided as a base product to individual billers, who may then achieve customization relatively easily by preparation of XML instruction scripts to be used with their processing and presentation of their billing data.

Repositories 120, 140, 154, and 152 may reside in any number or configuration of physical storage devices. Also, the data for those repositories may be stored in common or separate data organizational structures. As long as the information is retrievable, the data can be stored in any combination of appropriate formats, i.e., database, directory tree, etc.

While the present invention has been described in connection with what is presently considered to be the preferred embodiments, it is to be understood that the invention is not limited to the disclosed embodiment, but is intended to cover various modifications and equivalent arrangements included within the spirit and scope of the appended claims. It should also be understood that certain features of the system described herein may be considered novel inventions in their own right, even if separated from the overall system described herein, and that the scope of protection afforded to the patentee should be determined in view of the following appended claims.

What is claimed is:

1. An electronic bill presentment computer system for providing bill information from a biller to a remote customer over a network, the customer submitting a requested transaction to the electronic bill presentment computer system, the electronic bill presentment computer system configured and programmed to include:
a presentation descriptor repository, the presentation descriptor repository including data pertaining to the biller's particular look-and-feel for presentation of electronic billing results to the customer;
a presentation logic module providing a visual presentation of results of the requested transaction from the system to the customer, the presentation logic module utilizing look-and-feel data retrieved from the presentation descriptor repository; and
wherein the presentation descriptor repository is discrete from the presentation logic module, thereby providing that only said presentation descriptor repository, and not the presentation logic module, directly reflects a particular electronic billing presentation requirement of the biller, the information in said presentation descriptor repository being customizable for the biller.

2. The system of claim 1 wherein the presentation descriptor repository further includes:
a look-and-feel library including one or more presentation page templates; and wherein the presentation logic module further includes:
a look-and-feel object creating an appropriate presentation page template for the requested transaction.

3. The system of claim 2 wherein the one or more presentation page templates in the look-and-feel library are stored using descriptors in XML format.

4. The system of claim 1 wherein the presentation descriptor repository further includes:
a look-and-feel library including one or more presentation page templates;
a result descriptor repository including instructions for presenting particular kinds of electronic billing results, as suited for the biller's particular electronic billing needs; and
an element resource repository including cosmetic elements particular to the biller;
and wherein the presentation logic module further includes:
a look-and-feel object creating an appropriate presentation page template for the requested transaction; and
a formatting object cooperating with the look-and-feel object and formatting the electronic billing results in accordance with the instructions in the result descriptor repository and extracting cosmetic elements from the element resource repository, look-and-feel object and the formatting object thereby preparing a result presentation page to send to the customer in response to the transaction request.

5. The system of claim 4 wherein the one or more presentation page templates in the look-and-feel library are stored using descriptors in XML format.

6. An electronic bill presentment computer system for providing bill information from a biller to a remote customer over a network, the customer submitting a requested transaction to the electronic bill presentment computer system, the electronic bill presentment computer system configured and programmed to include:
an action descriptor repository including a script of the processing instructions corresponding to the requested transaction, the script being directed to particular electronic bill requirements of the biller and including one or more of the following: (a) an identification of business objects to instantiate, (b) a method to invoke the business objects, and (c) a presentation instruction;
a business logic module including a plurality of business objects for determining electronic billing results;
a presentation descriptor repository, the presentation descriptor repository including data pertaining to the biller's particular look-and-feel for presentation of electronic billing results to the customer;
a presentation logic module receiving electronic billing results from the business logic module and providing a visual presentation of the electronic billing results to the customer, the presentation logic module utilizing look-and-feel data retrieved from the presentation descriptor repository; and
an interaction controller receiving the requested transaction from the customer and retrieving the corresponding script of processing instructions from the action descriptor repository, the interaction controller invoking business objects in the business logic module and providing presentation instructions to the presentation logic module in accordance with the script of processing instructions;
wherein the action descriptor repository and the presentation descriptor repository are discrete from the business logic module, the presentation logic module, and the interaction controller, thereby providing that said repositories are the only part of the system directly reflecting the biller's particular electronic billing needs, the information in said repositories being customizable for the biller.

7. The system of claim 6 wherein the business logic module and the presentation logic module are separate and discrete within the system, thereby providing that one may be modified without requiring modification of the other.

8. The system of claim 6 wherein the presentation descriptor repository further includes:
a look-and-feel library including one or more presentation page templates;
a result descriptor repository including instructions for presenting particular kinds of electronic billing results, as suited for the biller's particular electronic billing needs; and
an element resource repository including cosmetic elements particular to the biller;
and wherein the presentation logic module further includes:
a look-and-feel object receiving presentation instructions from the interaction controller, the look-and-feel object creating an appropriate presentation page template for the requested transaction; and
a formatting object receiving electronic billing results from the business logic module and cooperating with the appropriate presentation page template from the look-and-feel object, the formatting object formatting the electronic billing results in accordance with the instructions in the result descriptor repository and extracting cosmetic elements from the element resource repository, the look-and-feel object and the formatting object thereby preparing a result presentation page to send to the customer in response to the transaction request.

9. The system of claim 8 wherein the one or more presentation page templates in the look-and-feel library are stored using descriptors in XML format.

10. The system of claim 6 wherein the script of processing instructions in the action descriptor repository is stored in XML format.

11. The system of claim 9 wherein the presentation descriptor repository comprises presentation information stored in XML format.

12. A method for providing electronic bill information from a biller to a remote customer over a network, the customer submitting a requested transaction, the method comprising:
storing customized data pertaining to a particular look-and-feel of the biller for presentation of electronic billing results to the customer;
storing presentation logic code independent of the data pertaining to the biller's particular look and feel;
activating the presentation logic code in accordance with the look-and-feel data retrieved from the stored data to create a visual presentation to be provided to the customer.

13. The method of claim 12 wherein the step of storing presentation logic code includes providing an update to the presentation logic code without affecting the customized data pertaining to the biller's particular look and feel.

14. The method of claim 12 wherein the step of storing data pertaining to the biller's particular look-and-feel includes storing descriptors in XML format.

15. A method for providing electronic bill information from a biller to a remote customer over a network, the customer submitting a requested transaction, the method comprising:
storing a customized script of the processing instructions corresponding to the requested transaction, the customized script being directed to the biller's particular electronic bill presentment needs and including one or more of the following: (a) an identification of business logic to instantiate, (b) a method to invoke the business logic, and (c) a presentation instruction;
storing business logic code independent of the customized script of processing instructions,
retrieving the customized script of processing instructions corresponding to the requested transaction;
applying the customized script of processing instructions to the business logic code and determining electronic billing results;
storing customized data pertaining to a particular look-and-feel of the biller for presentation of electronic billing results to the customer;
storing presentation logic code independent of the data pertaining to the biller's particular look and feel;
applying the presentation logic code in accordance with the customized look-and-feel data retrieved from the stored data to create a visual presentation of the electronic billing results from the business logic code to be provided to the customer.

16. The method of claim 15 wherein the step of storing business logic code includes providing an update to the business logic code without affecting the customized script of processing instructions.

17. The method of claim 15 wherein the step of storing a customized script of the processing instructions includes storing descriptors in XML format.

18. The method of claim 15 wherein the step of storing data pertaining to the biller's particular look-and-feel includes storing descriptors in XML format.

19. The method of claim 18 wherein the step of storing a customized script of the processing instructions includes storing descriptors in XML format.

20. A web page presenting electronic bill information from a biller over the Internet to a customer, the web page generated in response to a submission of a requested transaction by the customer, the web page further generated using a method as follows:
storing customized data pertaining to a particular look-and-feel of the biller for presentation of electronic billing results to the customer;
storing presentation logic code independent of the data pertaining to the biller's particular look and feel;
receiving the requested transaction from the customer via the Internet;
generating electronic billing results in response to the requested transaction;
activating the presentation logic code in accordance with the look-and-feel data retrieved from the stored customized data to create the web page representing a visual presentation of the electronic billing results to be provided to the customer; and
transmitting the web page to the customer via the Internet.

21. The web page of claim 20 wherein the method of generating the web page and the step of storing presentation logic code further includes providing an update to the presentation logic code without affecting the customized data pertaining to the biller's particular look and feel.

22. The web page of claim 20 wherein the method of generating the web page and the step of storing data pertaining to the biller's particular look-and-feel further includes storing descriptors in XML format.

23. A web page presenting electronic bill information from a biller over the Internet to a customer, the web page generated in response to a submission of a requested transaction by the customer, the web page further generated using a method as follows:
storing a customized script of the processing instructions corresponding to the requested transaction, the customized script being directed to a particular electronic bill presentment need of the biller and including one or more of the following: (a) an identification of business logic to instantiate, (b) a method to invoke the business logic, and (c) a presentation instruction;
storing business logic code independent of the customized script of processing instructions,
receiving the submission of the requested transaction;
retrieving the customized script of processing instructions corresponding to the requested transaction;
applying the customized script of processing instructions to the business logic code and determining electronic billing results;
storing customized data pertaining to a particular look-and-feel of the biller for presentation of electronic billing results to the customer;
storing presentation logic code independent of the data pertaining to the biller's particular look and feel;
applying the presentation logic code in accordance with the customized look-and-feel data retrieved from the stored data to create a visual presentation of the electronic billing results to be provided to the customer.

24. The web page of claim 23 wherein the method of generating the web page and the step of storing business logic code further includes providing an update to the business logic code without affecting the customized script of processing instructions.

25. The web page of claim 23 wherein the method of generating the web page and the step of storing a customized script of the processing instructions further includes storing descriptors in XML format.

26. The web page of claim 23 wherein the method of generating the web page and the step of storing data pertaining to the biller's particular look-and-feel further includes storing descriptors in XML format.

27. The web page of claim 26 wherein the method of generating the web page and the step of storing a customized script of the processing instructions further includes storing descriptors in XML format.
